(19) United States
(12) Patent Application Publication
(10) Pub. No.: US 2026/0092655 A1
(43) Pub. Date: Apr. 2, 2026

(54) VALVE DEVICE AND LEAK DETECTION METHOD

(71) Applicants: TOKYO ELECTRON LIMITED, Tokyo (JP); FUJIKIN INCORPORATED, Osaka (JP)

(72) Inventors: Takahiro HAYASHIDA, Koshi City (JP); Toshihide YOSHIDA, Osaka (JP); Tadayuki YAKUSHIJIN, Osaka (JP); Keisuke ISHIBASHI, Osaka (JP); Masaya AISHIMA, Osaka (JP); Miyu UCHIDA, Osaka (JP); Tomohiro NAKATA, Osaka (JP); Kazunari WATANABE, Osaka (JP); Ryutaro TANNO, Osaka (JP); Yuya SUZUKI, Osaka (JP)

(21) Appl. No.: 19/413,022

(22) Filed: Dec. 9, 2025

Related U.S. Application Data
(63) Continuation of application No. PCT/JP2024/020988, filed on Jun. 10, 2024.

(30) Foreign Application Priority Data
Jun. 21, 2023 (JP) 2023-101631

(51) Int. Cl. F16K 37/00; F16K 7/12; G01K 1/08; G01M 3/00

(52) U.S. Cl. CPC F16K 37/005; G01M 3/002; F16K 7/126; G01K 1/08

(57) ABSTRACT

A valve device includes: a body formed with an inflow passage and an outflow passage and provided with a valve seat; a valve element that contacts and separates from the valve seat to enable communication and blocking between the inflow passage and the outflow passage; a sensor cover having a tip portion located within the outflow passage; and a temperature sensor inserted into the sensor cover and having a tip that contacts the tip portion of the sensor cover. The tip portion of the sensor cover and the tip of the temperature sensor are located near the valve seat.

### CROSS REFERENCE TO RELATED APPLICATION

This application is a continuation application under 35 U.S.C. § 120 of No. PCT/JP2024/020988, filed Jun. 10, 2024, which is incorporated herein by reference and which claims priority to Japanese Application No. 2023-101631, filed Jun. 21, 2023. The present application likewise claims priority under 35 U.S.C. § 119 to Japanese Application No. 2023-101631, filed Jun. 21, 2023, the entire content of which is also incorporated herein by reference.

### TECHNICAL FIELD

The present disclosure relates to a valve and a leak detection method used in semiconductor manufacturing equipment and the like.

### BACKGROUND

A supercritical cleaning apparatus is known, which includes a chamber and a plurality of valves and performs cleaning using an inert gas (e.g., carbon dioxide (CO₂)). The chamber and the plurality of valves are connected by piping, and a plurality of pressure gauges are installed in the piping.

### SUMMARY

In the above supercritical cleaning apparatus, when phenomena such as the pressure in the chamber decreasing despite the valve devices being in a closed state occur, a leak has occurred in one of the valve devices, and it is necessary to identify and replace the valve device in which the leak has occurred. Since the valve devices themselves do not have a function to detect leaks, an attempt is made to identify the valve device in which the leak has occurred based on the measured value of the pressure gauges. However, while the measured values of the pressure gauges can narrow down the approximate range of the installation location of the valve device in which the leak has occurred, it is difficult to identify the specific valve device in which the leak has occurred. Therefore, it is necessary to replace all valve devices that may potentially have a leak.

Accordingly, an object of the present disclosure is to provide a valve device and a leak detection method capable of easily detecting a leak.

A valve device according to one embodiment of the present disclosure includes: a body formed with an inflow passage and an outflow passage and provided with a valve seat; a valve element that contacts and separates from the valve seat to enable communication and blocking between the inflow passage and the outflow passage; a sensor cover having a tip portion located within the outflow passage; and a temperature sensor inserted into the sensor cover and having a tip that contacts the tip portion of the sensor cover. The tip portion of the sensor cover and the tip of the temperature sensor are located near the valve seat.

### BRIEF DESCRIPTION OF THE DRAWINGS

In the drawings:

FIG. 1 is a schematic cross-sectional view of a valve portion of a valve device according to an embodiment;

FIG. 2 is a schematic enlarged cross-sectional view of a vicinity of a temperature detection unit of the valve device;

FIG. 3 is a graph showing a relationship between leak amount and temperature change of a temperature sensor in the case where a leak occurs;

FIG. 4 is a schematic cross-sectional view of a valve portion of a valve device according to a modified embodiment; and

FIG. 5 is a schematic cross-sectional view of a valve portion of a valve device according to a modified embodiment.

### DETAILED DESCRIPTION

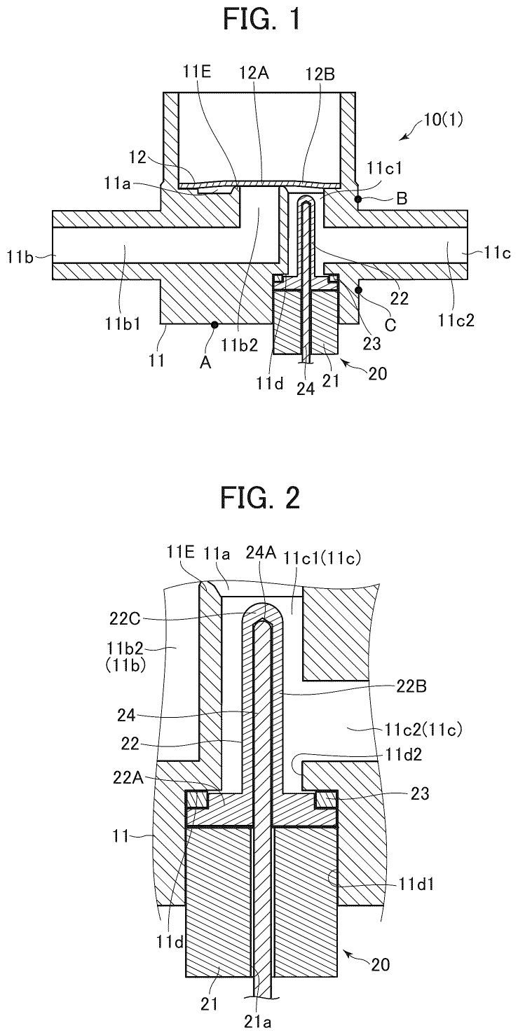

A valve device 1 and a leak detection method for detecting a leak in the valve 1 according to an embodiment of the present disclosure will be described with reference to the drawings. FIG. 1 is a schematic cross-sectional view of a valve portion 10 of the valve device 1 according to the present embodiment. FIG. 2 is a schematic enlarged cross-sectional view of a vicinity of a temperature detection unit 20 of the valve device 1.

As shown in FIG. 1, the valve device 1 includes a valve portion 10 and an actuator (not shown). In the following description, the valve portion 10 of the valve device 1 will be described with the diaphragm 12 side as an upper side and the temperature detection unit 20 side as a lower side. The valve device 1 according to the present embodiment is in a closed state in a normal state (a state in which driving fluid is not supplied to the actuator).

The valve portion 10 includes a body 11, a diaphragm 12, and a temperature detection unit 20. In the present embodiment, the left side of the body 11 is a primary side, and the right side of the body 11 is a secondary side.

The body 11 is made of, for example, stainless steel. The body 11 is formed with a valve chamber 11a, an inflow passage 11b, an outflow passage 11c, and an insertion hole 11d. The inflow passage 11b and the outflow passage 11c communicate with the valve chamber 11a. The inflow passage 11b includes a first inflow passage 11b1 extending rightward from its inlet and a second inflow passage 11b2 extending upward from an end of the first inflow passage 11b1. The upper end of the second inflow passage 11b2 communicates with the valve chamber 11a. In the body 11, the peripheral portion of the location where the second inflow passage 11b2 and the valve chamber 11a communicate constitutes an annular seat 11E serving as a valve seat. The outflow passage 11c includes a first outflow passage 11cl extending downward from the valve chamber 11a and a second outflow passage 11c2 extending rightward from the lower end of the first outflow passage 11c1.

As shown in FIG. 2, the insertion hole 11d is formed to penetrate from the lower surface of the body 11 to the first outflow passage 11c1. The insertion hole 11d has a counterbored shape and includes, from the lower side, a large-diameter portion 11d1 and a small-diameter portion 11d2. The inner diameter of the small-diameter portion 11d2 is smaller than the inner diameter of the large-diameter portion 11d1. A female screw thread is formed on the inner periphery of the large-diameter portion 11d1. The small-diameter portion 11d2 communicates with the first outflow passage 11c1. The temperature detection unit 20 is provided in the insertion hole 11d.

As shown in FIG. 1, the diaphragm 12, which serves as a valve element, is held with its outer peripheral edge clamped between a pressing adapter (not shown) and a bottom surface forming the valve chamber 11a of the body 11. The diaphragm 12 is made of metal, and is constituted by, for example, a nickel-cobalt alloy, stainless steel, or the like. The diaphragm 12 separates from and contacts (presses against) the seat 11E, thereby enabling communication and blocking between the inflow passage 11b and the outflow passage 11c. The diaphragm 12 includes a central portion 12A and a peripheral portion 12B located around the central portion 12A. The central portion 12A is the portion located inside the seat 11E when the diaphragm 12 contacts the seat 11E. The upper end of the second inflow passage 11b2 faces the central portion 12A, and the upper end of the first outflow passage 11cl faces the peripheral portion 12B.

The central portion 12A of the diaphragm 12 is configured to be pressed by a diaphragm presser (not shown). The diaphragm presser is held by a holder (not shown), and the holder is connected to a stem of the actuator. A compression coil spring (not shown) constantly urges the holder downward, so that the valve device 1 is maintained in a closed state during normal operation (when the actuator is not operating).

The actuator is, for example, air-driven. By means of the driving fluid, the stem, holder, and diaphragm presser (not shown) move to a side away from the diaphragm 12, causing the diaphragm 12 to separate from the seat 11E, thereby allowing communication between the inflow passage 11b and the outflow passage 11c, and bringing the valve device 1 into an open state.

Next, the temperature detection unit 20 will be described with reference to FIG. 2. The temperature detection unit 20 includes a bonnet 21, a sheath tube 22, a gasket 23, and a temperature sensor 24.

The bonnet 21 has a substantially cylindrical shape, and a through-hole 21a is formed at its center. A male thread is formed on the outer periphery of the upper portion of the bonnet 21. The bonnet 21 is inserted into the insertion hole 11d and screwed into the large-diameter portion 11d1.

The sheath tube 22, which serves as a sensor cover, has a substantially cylindrical shape and is made of, for example, stainless steel. The sheath tube 22 is configured separately from the body 11. The sheath tube 22 includes a fixing portion 22A and a sensor support portion 22B. The fixing portion 22A has a substantially annular shape and is fixed to the body 11 by the bonnet 21. The sensor support portion 22B extends upward from the inner peripheral edge of the fixing portion 22A, passes through the small-diameter portion 11d2, and extends toward the diaphragm 12 within the first outflow passage 11c1. That is, the sensor support portion 22B extends in a direction parallel to the flow direction of the fluid. The outer peripheral surface of the sensor support portion 22B does not contact the inner surface of the body 11 and has a clearance from the inner surface of the body 11. The tip portion 22C of the sensor support portion 22B has a hemispherical shape and is located within the first outflow passage 11c1. The tip portion 22C is separated from the fixing portion 22A by at least a predetermined distance. The predetermined distance is set based on the volume of the fixing portion 22A, the volume of the portion of the sensor support portion 22B between the fixing portion 22A and the tip portion 22C, the thermal conductivity of the material constituting the sheath tube 22, and the like.

The gasket 23 has an annular shape, is located within the large-diameter portion 11d1, and is provided between the fixing portion 22A and the body 11. The gasket 23 is pressed against the body 11 via the fixing portion 22A by the bonnet 21. The gasket 23 seals between the outflow passage 11c and the exterior of the body 11.

The temperature sensor 24 includes, for example, a thermocouple and is inserted into the sheath tube 22 through the through-hole 21a of the bonnet 21. The tip 24A of the temperature sensor 24 contacts the tip portion 22C of the sensor support portion 22B. The tip portion 22C of the sheath tube 22 and the tip 24A of the temperature sensor 24 are located near the seat 11E and face the peripheral portion 12B of the diaphragm 12. That is, the tip portion 22C of the sheath tube 22 and the tip 24A of the temperature sensor 24 are located outside the annular seat 11E. The temperature sensor 24 can detect the temperature of the fluid near the seat 11E. Additionally, as described above, the entire temperature detection unit 20 is configured separately from the body 11. This allows the valve device 1 to comply with high-pressure gas certification.

Next, a leak detection method for detecting a leak in the valve device 1 will be described. Here, a leak refers to an internal leak in which fluid flows from the primary side to the secondary side in the closed state of the valve device 1.

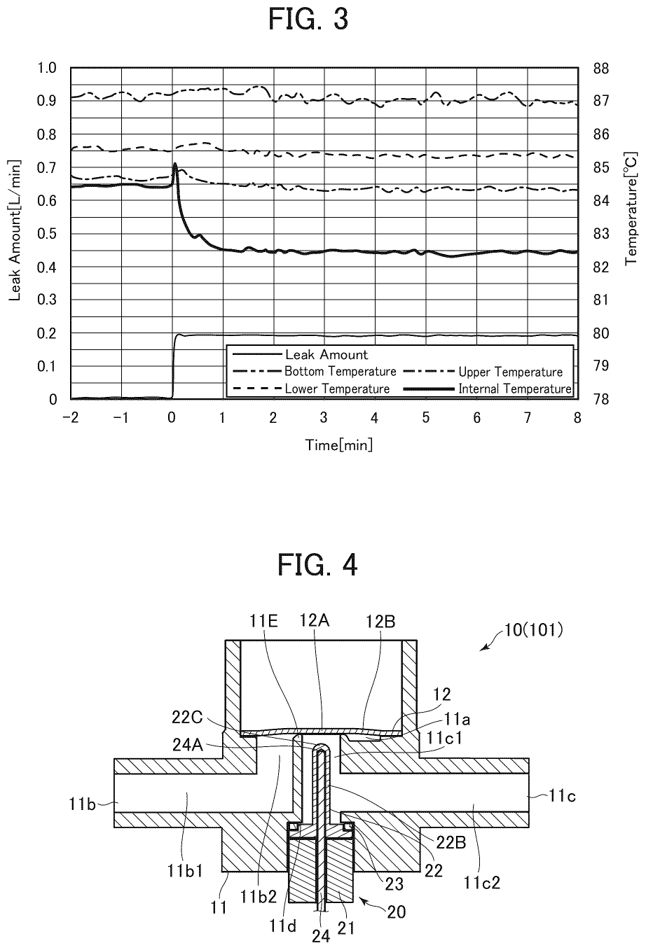

FIG. 3 is a graph showing the relationship between the leak amount and the temperature change of the temperature sensor in the case where a leak occurs.

In a state where the body 11 is heated to, for example, 90° C. and maintained, the internal temperature of the secondary side of the body 11 is measured by the temperature sensor 24. The temperatures at the bottom position A, the upper side surface position B of the secondary side, and the lower side surface position C of the secondary side of the body 11 (each indicated by a black circle in FIG. 1) are measured by a temperature sensor (not shown). Furthermore, a flow meter is installed on the secondary side (outflow passage 11c side) of the body 11.

In this state, the valve device 1 is brought into a closed state, and a supercritical fluid (e.g., carbon dioxide (CO2): 19 MPa, 90° C., 0.25 L/min) is introduced into the primary side (inflow passage 11b side), while the secondary side is open to the atmosphere. When no leak occurs, the temperature sensor 24 indicates a substantially constant measured temperature. When a leak occurs, the high-pressure fluid undergoes adiabatic expansion near the diaphragm 12, causing the surrounding temperature to decrease. As shown in FIG. 3, by measuring this temperature decrease with the temperature sensor 24, a leak can be detected. For example, if the temperature measured by the temperature sensor 24 after the elapse of a predetermined time (e.g., 2 minutes) from the start of the supercritical fluid inflow has decreased by a predetermined temperature (e.g., 1.0° C.) or more compared to the temperature measured by the temperature sensor 24 prior to the start of the supercritical fluid inflow, it can be detected that a leak is occurring. On the other hand, even if the temperatures at the bottom position A, the upper side surface position B of the secondary side, and the lower side surface position C of the secondary side of the body 11 are measured by a temperature sensor, since the body 11 is heated, there is almost no temperature change, and thus the temperature decrease due to the adiabatic expansion of the fluid cannot be detected.

According to the valve device 1 of the present embodiment, since the tip portion 22C of the sheath tube 22 and the tip 24A of the temperature sensor 24 are located near the seat 11E, the temperature decrease due to the adiabatic expansion of the fluid can be detected, making it possible to easily detect a leak.

Since the tip portion 22C of the sensor support portion 22B is separated from the fixing portion 22A by at least a predetermined distance, the influence of heat due to the heating of the body 11 during leak detection can be suppressed. Since the bonnet 21 is screwed to the body 11 and presses the gasket 23 via the fixing portion 22A, the gasket 23 can seal between the outflow passage 11c and the exterior of the body 11.

The present disclosure is not limited to the above-described embodiment. Those skilled in the art can make various additions, modifications, and the like within the scope of the present disclosure.

In the above embodiment, the tip portion 22C of the sheath tube 22 and the tip 24A of the temperature sensor 24 face the peripheral portion 12B of the diaphragm 12. However, as shown in a valve device 101 of FIG. 4, the tip portion 22C of the sheath tube 22 and the tip 24A of the temperature sensor 24 may be configured to face the central portion 12A of the diaphragm 12. That is, the tip portion 22C of the sheath tube 22 and the tip 24A of the temperature sensor 24 are located inside the annular seat 11E. In this modified embodiment, a peripheral portion of a region where the first outflow passage 11cl communicates with the valve chamber 11a in the body 11 constitutes an annular seat 11E serving as a valve seat. The upper end of the second inflow passage 11b2 faces the peripheral portion 12B, and the upper end of the first outflow passage 11cl faces the central portion 12A. According to the valve device 101 of this modified embodiment, since the tip portion 22C of the sheath tube 22 and the tip 24A of the temperature sensor 24 can be brought closer to the central portion 12A of the diaphragm 12, minute leaks can be detected. Additionally, since the fluid load on the diaphragm 12 is reduced, the lifespan of the diaphragm 12 can be extended, and external leaks can be prevented.

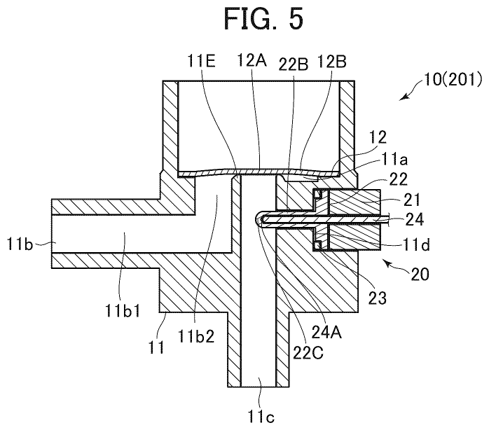

In the valve device 101 of FIG. 4, the sensor support portion 22B extends in a direction parallel to the flow direction of the fluid. However, as shown in a valve device 201 of FIG. 5, the sensor support portion 22B may extend in a direction orthogonal to the flow direction of the fluid. In this modified embodiment, the outflow passage 11c has a straight shape extending downward and does not have a bent portion. The insertion hole 11d is formed to be orthogonal to the outflow passage 11c, and the temperature detection unit 20 is provided in the insertion hole 11d. According to the valve device 201 of this modified embodiment, the degree of freedom in the installation direction of the valve device 201 is increased, and the wiring outlet of the temperature sensor 24 can be arbitrarily set. Since the outflow passage 11c does not have a bent portion, the size of the body 11 can be reduced, achieving space savings. Additionally, in the valve device 1 of FIG. 1, similarly to the valve device 201 of FIG. 5, the outflow passage 11c may be formed in a straight shape extending downward, the insertion hole 11d may be formed to be orthogonal to the outflow passage 11c, and the temperature detection unit 20 may be provided in the insertion hole 11d.

In the valve devices 1, 101, and 201 shown in FIGS. 1, 3, and 4, the clearance between the outer peripheral surface of the sensor support portion 22B and the inner surface of the body 11 is made small to facilitate leak detection, but the clearance may be made large. As a result, the thermal influence exerted by the heated body 11 on the temperature sensor 24 during leak detection can be reduced.

The sheath tube 22 is configured as a separate member from the body 11, but for example, the body 11 and the sheath tube 22 (sensor cover) may be integrally formed using a 3D printer and the like. In this case, the bonnet 21 may not be necessary. The sheath tube 22 may be fixed to the body 11 by welding or by bolts and the like. A male thread may be provided on the outer periphery of the fixing portion 22A of the sheath tube 22 to allow the sheath tube 22 to be screwed into the insertion hole 11d. Any method may be used to fix the sheath tube 22 to the body 11 as long as the liquid tightness between the interior and exterior of the body 11 can be ensured.

In leak detection, for example, the measured temperature by the temperature sensor 24 after the elapse of a predetermined time from the start of the inflow of the supercritical fluid is compared with the measured temperature by the temperature sensor 24 prior to the start of the inflow of the supercritical fluid. However, the measured temperature by the temperature sensor 24 after the elapse of a predetermined time from the start of the inflow of the supercritical fluid may be compared with the measured temperature by the temperature sensor 24 simultaneously with or immediately after the start of the inflow of the supercritical fluid. In leak detection, the secondary side is open to the atmosphere, but it is not necessary to open it to the atmosphere if there is a certain pressure difference between the primary side and the secondary side. A washer may be provided between the bonnet 21 and the fixing portion 22A of the sheath tube 22.

What is claimed is:

1. A valve device comprising:
a body formed with an inflow passage and an outflow passage and provided with a valve seat;
a valve element that contacts and separates from the valve seat to enable communication and blocking between the inflow passage and the outflow passage;
a sensor cover having a tip portion located within the outflow passage; and
a temperature sensor inserted into the sensor cover and having a tip that contacts the tip portion of the sensor cover,
wherein the tip portion of the sensor cover and the tip of the temperature sensor are located near the valve seat.

2. The valve device according to claim 1, further comprising a bonnet, wherein the body is formed with an insertion hole communicating with the outflow passage, into which the bonnet is inserted,
the sensor cover is configured separately from the body,
the sensor cover includes a sensor support portion that has the tip portion and a fixing portion that is fixed to the body by the bonnet, and
the tip portion is separated from the fixing portion by at least a predetermined distance.

3. The valve device according to claim 2, further comprising a gasket provided between the fixing portion and the body,
wherein the bonnet is screwed to the body and presses the gasket via the fixing portion.

4. The valve device according to claim 1, wherein the tip portion of the sensor cover and the tip of the temperature sensor face a central portion of the valve element.

5. The valve device according to claim 1, wherein the valve element includes a central portion and a peripheral portion around the central portion, and the tip portion of the sensor cover and the tip of the temperature sensor face the peripheral portion of the valve element.

6. The valve device according to claim 2, wherein the sensor support portion extends in a direction parallel to a flow direction of a fluid.

7. The valve device according to claim 2, wherein the sensor support portion extends in a direction orthogonal to a flow direction of a fluid.

8. A leak detection method for detecting a leak in the valve device according to claim 1, the method comprising:
bringing the valve element into contact with the valve seat to block communication between the inflow passage and the outflow passage;
supplying a fluid into the inflow passage; and
detecting a temperature with the temperature sensor and detecting a leak based on a change in a detected temperature.
